(19) United States
(12) Patent Application Publication
(10) Pub. No.: US 2007/0296598 A1
(43) Pub. Date: Dec. 27, 2007

(54) Apparatus for identifying support tray data and method thereof

(76) Inventor: Jun Ho Kim, Taegu (KR)

Correspondence Address: PARK LAW FIRM, 3255 WILSHIRE BLVD, SUITE 1110, LOS ANGELES, CA, 90010, US

(21) Appl. No.: 11/600,435

(22) Filed: Nov. 16, 2006

(30) Foreign Application Priority Data
Jun. 21, 2006 (KR) 10-2006-0055993
Sep. 20, 2006 (KR) 10-2006-0091298

(51) Int. Cl. G08B 13/14

(52) U.S. Cl. 340/572.8

(57) ABSTRACT

An apparatus for identifying information regarding an auxiliary tray used to supply medicines to a tray of a special tablet system for an automatic medicine packing system, includes an electronic tag that is attached on a predetermined location on the auxiliary tray, an information reader that retrieves information from the electronic tag without contacting the electronic tag and a terminal that compares information read from the electronic tag and a prescription information. The terminal recognizes the auxiliary tray as the correct auxiliary tray if the informations are the same, and issues an alarm if the informations are different. The apparatus further includes a marking device that is installed on the auxiliary tray and visually displays medicine information and patient information and a marking device controller that is connected to the marking device and a POS system via communication network, and transmits marking information to the marking device.

### CLAIMING FOREIGN PRIORITY

The applicant claims and requests a foreign priority, through the Paris Convention for the Protection of Industrial Property, based on patent applications filed in the Republic of Korea (South Korea) with the filing date of Jun. 21, 2006 with the patent application number 10-2006-0055993 and with the filing date of Sep. 20, 2006 with the patent application number 10-2006-0091298 by the applicant, the contents of which are incorporated by reference into this disclosure as if fully set forth herein.

### BACKGROUND OF THE INVENTION

The present invention relates to information retrieval for an auxiliary tray of an automatic medicine packing apparatus. More particularly, this invention relates to a method and an apparatus that retrieves identification information for STS (Special Tablet System) in a non-contact way. The invention also relates to a method and apparatus that identifies information of an auxiliary tray with electronic shelf label system.

A human being is constantly threatened by various diseases during his or her lifetime, and sometimes suffers such disease. There have been ongoing efforts to treat diseases and many medicines have been developed.

Even though there are cases in which a disease can be cured with a single medicine, plural diseases outbreak in a human body and show complex symptoms. Therefore, mixtures of plural medicines are prescribed to treat such multiple symptoms. Medicines are manufactured in tablets or powdered medicine, and packed by one dose according to prescription.

Generally, in order to pack medicines, a sheet for heat bonding is folded to be overlapped, and the folded sheet is heat bonded per constant pitch to form a plurality of pockets, and medicines are poured into the pocket and the opening is sealed, thereby forming a pack for the medicine per dose.

Manually performing such packing operation requires a lot of manpower and time. Automatic medicine-packing apparatus was developed to solve such problem.

Generally, an automatic medicine-packing apparatus stores medicines classified in a plurality of cassettes, and discharges tablets according to a prescription and packs the tablets per dose. The cassettes are housed into a plurality of cartridges. Each cassette is separately controlled to discharge a tablet that it contains. The discharged tablet falls through passages provided in the cartridges. The tablets are collected into a hopper and then the collected tablets are discharged downward from the hopper and sealed with a sealing device and sealing envelopes.

Generally, an automatic medicine-packing apparatus includes a special table system (STS) that handles a half of a tablet, or special medicines that are not contained by the cassette.

FIG. 1 schematically shows an STS 10 that is used in a general automatic medicine-packing apparatus.

The STS 10 includes a slide member 11 that is automatically opened with a button operation and is closed manually, and a tray 12 that rests on the slide member 11 and supplies medicines including half tablet and special medicine that are not contained in the cassettes.

FIGS. 2a and 2b show an auxiliary tray 20 that facilitates setting of medicines by a pharmacist on the tray 12.

FIG. 2a illustrates the auxiliary tray as viewed from the top, and FIG. 2b illustrates the auxiliary tray as viewed from the bottom.

The auxiliary tray 20 includes a slide plate 21 and a lever 22 that facilitates movement of the slide plate 21. A bar code sticker 23 is attached to one side of the auxiliary tray 20 to display information for medicines that are contained in the auxiliary tray 20.

A pharmacist presets medicines and moves them manually with the auxiliary tray 20, and when she pulls the lever 22 with the tray 12 of the STS 10 and the auxiliary tray 20 overlapped, the medicines set in the auxiliary tray 20 are received in the corresponding positions of the tray 12.

Then the pharmacist pushes the slide member 11 to insert the tray 12 into STS. Afterwards, an internal control device automatically supplies the medicines and auto packaging is performed.

The auxiliary tray 20 by prior art do not have a separate function to store patient and medical information. A barcode sticker with medicine information recorded is attached on a front surface of the auxiliary tray 20 to provide information on medicines that are set on a particular auxiliary tray 20. In order to retrieve information on medicines set in the auxiliary tray 20, the user uses a bar code scanner to read the information stored in the bar code sticker 23.

The disadvantages of this method are that a barcode sticker should be made for each batch of medicines, and the barcode thus made should be attached to the corresponding auxiliary tray. The barcode is for just one time use. If the auxiliary tray is used for containing other medicines, the already attached barcode sticker should be detached and eliminated, and a new barcode sticker should be made and attached. Also, the user should handle the barcode scanner manually, and take cautions in the checking process.

### SUMMARY OF THE INVENTION

The present invention contrives to solve the disadvantages of the prior art.

An objective of the invention is to provide a device and a method for identifying auxiliary tray data without contacting the auxiliary tray.

Another objective of the invention is to provide a device and a method for identifying auxiliary tray data that enable repeated use of an identification tag.

Still another objective of the invention is to provide a device and method for identifying auxiliary tray data that enable storing large amount of information in the identification tag.

Still another objective of the invention is to provide a device and method for identifying auxiliary tray data that facilitate a user to identify the data by displaying the data in real time.

In order to achieve the above objectives, the present invention provides an apparatus for identifying information regarding an auxiliary tray. The auxiliary tray is used to supply medicines to a tray of a special tablet system for an automatic medicine packing system and the tray is positioned on a slide member. The apparatus includes an electronic tag that is attached on a predetermined location on the auxiliary tray and stores patient and medicine information, an information reader that retrieves information from the electronic tag without contacting the electronic tag, and a terminal that compares information read from the electronic tag and a prescription information. The terminal recognizes the auxiliary tray as the correct auxiliary tray if the informations are the same, and issues an alarm if the informations are different.

The apparatus further includes an alarm device that is connected to the controller and generates an alarm.

The electronic tag is an RFID tag, and the information reader is an RFID information reading device.

The medicine information and the patient information stored in the RFID tab can be changed.

The RFID information reading device includes an RFID reader that reads information stored in the RFID tag, a central processing unit that controls transmission of information read with the RFID reader, and a transceiver that transmits information that is output from the central processing unit to an external device according to a predetermined communication protocol.

The RFID information reader is attached on a predetermined location on the slide member.

The terminal includes a transceiver that receives an auxiliary tray reading information that is transmitted from the RFID information reading device, a control unit that compares the auxiliary tray reading information and the prescription information that is supplied in advance, and issues alarm control signal if the informations are different, a display that displays the auxiliary tray reading information and the prescription information on a screen, a memory that stores the prescription information and a program for the comparison and issuing alarm, and an alarm signal generation unit that generates alarm signal when the control unit issues alarm control signal, and transmits the alarm signal to the alarm device.

The control unit includes an interface part for data interface between the transceiver, the display, the alarm signal generation part, the memory, and the external device, a data comparison part that compares the auxiliary tray information and the prescription information, an alarm signal control part that controls generation of alarm signal, and a display control part that controls the display.

The alarm device is attached on a predetermined location on the slide member, and generates a visual and/or audible alarm.

The present invention provides a method for identifying information regarding an auxiliary tray. The auxiliary tray is used to supply medicines to a tray of a special tablet system for an automatic medicine packing system, and the tray is positioned on a slide member. The method includes steps of initializing the system when the system is turned on, checking whether prescription information is received, storing the prescription information in a memory when there is prescription information received, checking whether auxiliary tray identification information is received, comparing the prescription information and the auxiliary tray identification information when the auxiliary tray identification information is received, and displaying comparison result on a display when the informations are the same, and displaying comparison result on the display and generating alarm when the informations are different.

In another embodiment, the present invention provides an apparatus for identifying information regarding an auxiliary tray. The auxiliary tray is used to supply medicines to a tray of a special tablet system for an automatic medicine packing system. The tray is positioned on a slide member. The apparatus includes a marking device that is installed on the auxiliary tray and visually displays medicine information and patient information, and a marking device controller that is connected to the marking device and a POS system via communication network, and transmits marking information to the marking device. The marking information comprises medicine information and patient information.

The marking device includes a wireless communication unit that receives the marking information that was transmitted from the marking device controller and transmits identification information to the marking device controller, a signal processing unit that removes noise from the received signal, extracts pure data signal and converts it into a digital signal, a control unit that performs authentication and analysis of the signal processed by the signal processing unit and as a result of the authentication/analysis, if the signal is of its own, controls change of currently displayed information, a memory stores program for authentication/analysis of information and information for display, and is connected to the control unit, an information change unit that performs change of displayed information according to the control of the control unit, and a display unit that displays information of the auxiliary tray according to output of the information change unit.

The marking device displays the medicine information and the patient information visually, and includes a price card, liquid crystal display, flexible numeric display, or DOT matrix, that can change information that is displayed.

The control unit includes a data processing module that processes the received data and separates a unique number and data, an authentication module that performs authentication by comparing the separated unique number and its own unique number that is stored in the memory, and a control module that controls the received data to be stored in the memory via a storage module and controls the change information to be output via a change information output module when the unique numbers are the same. The change information output module outputs the change information according to the control of the control module.

The marking device controller includes an input unit that receives input for information to be recorded to the marking device and information that changes, a communication unit that communicates with a POS system and receives record information and change information for each marking device in real time, a central processing unit that is connected to the input unit and the communication unit and controls transmission of the marking information and the change information, a marking unit that displays transmission data for a particular marking device, and a wireless communication unit that that transmits marking information to the marking device.

With the above construction, the present invention had advantages that: (1) the support tray data identification device can automatically identify auxiliary tray information without contact; (2) inconvenience of manual identification is eliminated; (3) the accuracy of data identification is improved; (4) preparation error due to misidentification of auxiliary tray is prevented in advance; and (5) the information of the auxiliary tray is easily recognized with the electronic shelf label system.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic perspective view showing an STS that is used in a general automatic medicine-packing apparatus;

FIG. 2a is a perspective view showing an auxiliary tray as viewed from the top;

FIG. 2b is a perspective view showing the auxiliary tray as viewed from the bottom;

FIG. 3 is a block diagram showing an information recognition device according to the present invention;

FIG. 4 is a flow diagram showing an information recognition method according to the present invention;

FIG. 5 is a perspective view showing an auxiliary tray with a marking device;

FIG. 6 is a block diagram showing a second embodiment of an apparatus for identifying auxiliary tray data; and

FIG. 7 is a block diagram showing a auxiliary tray information marking device.

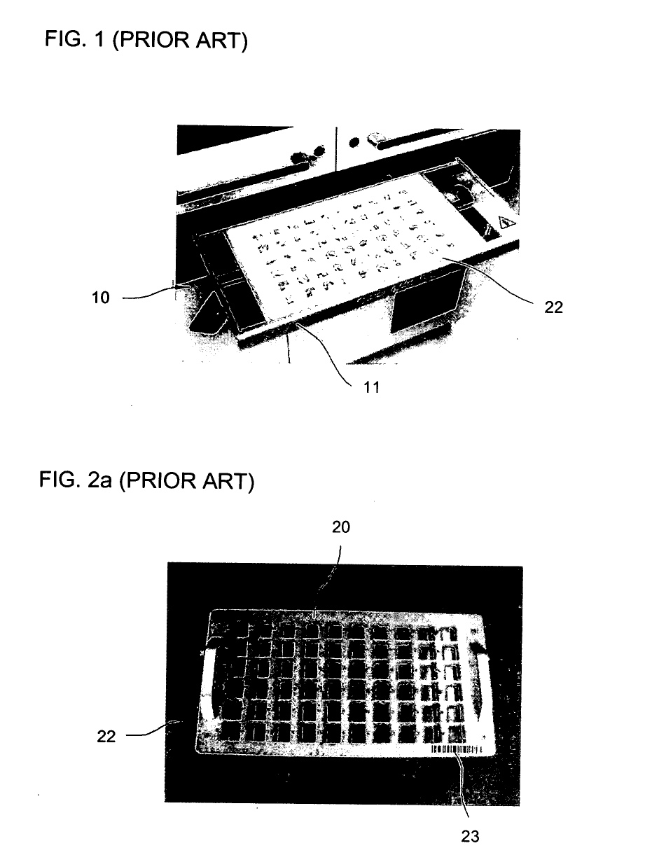

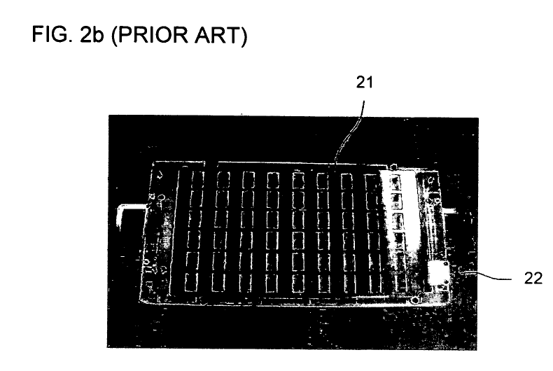

### DETAILED DESCRIPTION OF THE INVENTION

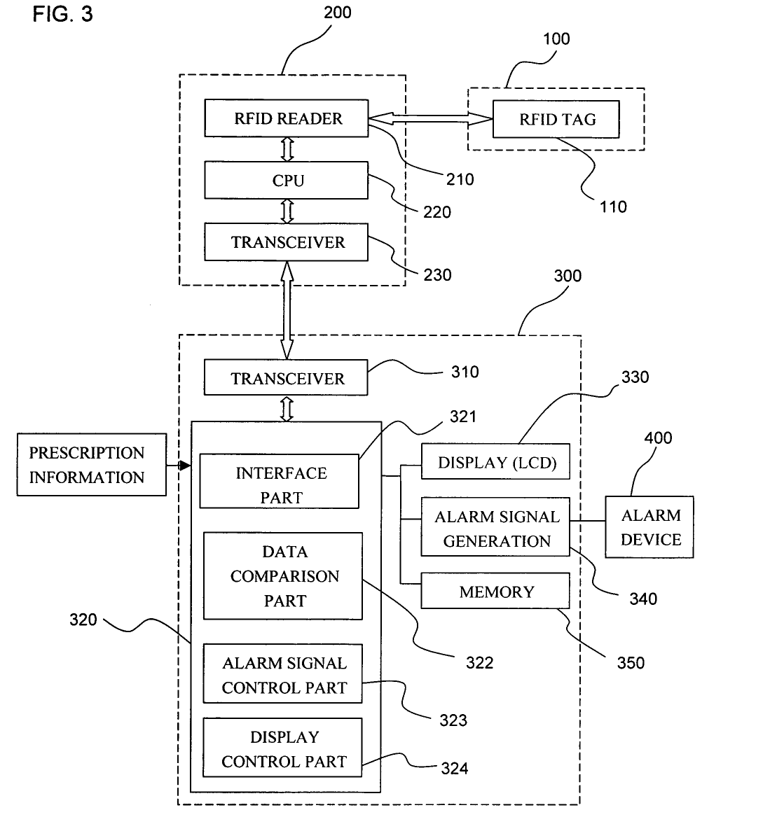

FIG. 3 shows a first embodiment of an information recognition device that recognizes information for an auxiliary tray 100 according to the present invention. An RFID tag 110 is attached on the auxiliary tray 100. Patient and medicine information recorded in the RFID tag may be changed.

An RFID information reading device 200 is provided to read information in the RFID tag 110 without contacting the tag. The RFID information reading device 200 includes an RFID reader 210 that reads data stored in the RFID tag 110, a central processing unit, CPU 220 that controls transmission of data read by the RFID reader 210, and a transceiver 230 that transmits data, which is output from the CPU 220, to an outside device with a predetermined communication protocol. The RFID information reading device 200 is attached to a predetermined location on a slide member.

A terminal 300 is provided to compare patent and medicine information that is read by the RFID information reading device 200, and a prescription information that is input from outside, and to recognize the auxiliary tray 100 if the they are the same, and to issue an alarm if they are different with each other. The terminal 300 includes a transceiver 310 that receives data transmitted from the RFID information reading device 200, a control unit 320 that compares data transmitted by the transceiver 310 and a pre-stored prescription data, and issues alarm control signal when they are different to prevent preparation error, a display 330 that displays the data read from the auxiliary tray and the prescription data, a memory 350 that stores the prescription data and programs for comparing data and generating alarm, and an alarm signal generation unit 340 that generates corresponding alarm signal when the control unit 320 outputs alarm control signal.

The control unit 320 includes an interface part 321 for data interface between the transceiver 310, the display 330, the alarm signal generation part 340, the memory 350, and external devices; a data comparison part 322 that compares the data from the auxiliary tray and the prescription data; an alarm signal control part 323 controls generation of alarm signal, and a display control part 324 that controls the display 330.

An alarm device 400 is provided to generate alarm for preventing preparation error, and is connected to the terminal 300. The alarm device 400 is installed on a predetermined location on the slide member 11. The alarm device 400 may be a visual alarm such as LED, or an audio alarm.

The operation of the information recognition device having the above construction is explained below. A pharmacist sets medicines for a particular student on the auxiliary tray 100. She uses an RFID reader (not shown) to record data regarding set on the auxiliary tray 100, and the patient to whom the medicines will be administered, etc. on the RFID tag 110. The data stored on the RFID tag 110 may be changed. While the RFID tag 110 may be attached on any part of the auxiliary tray 100, it is preferable to attach the tag to a position so that the tag does not interfere with the pharmacist's body. A single RFID tag is attached on each auxiliary tray. When patient data and medicine data are changed, the changed data is recorded with an RFID reader. There is no need to change the RFID tag 110 as in the prior art.

A user manually moves the auxiliary tray 100 with the RFID tag 110 attached and positions it near a predetermined location on the tray 12 that is positioned on the slide member 11. Then the RFID reader 210 of the RFID information reading device 200 that is attached on the predetermined location on the slide member 11 reads the patient and medicine data recorded in the RFID tag 110 without contact. The data read is transmitted to the terminal 300 through the transceiver 230 by the CPU 220.

The control unit 320 of the terminal 300 receives prescription data from outside via the interface part 321 and stores the received data in the memory 350. With the prescription data stored in the memory 350, when the transceiver 310 receives auxiliary tray data (patient information, medicine information) from the RFID information reading device 200, the display control part 324 controls the display 330 to show the data, and the data comparison part 322 compares the auxiliary tray data and the prescription data stored in the memory 350. As a result of the comparison, if the data coincide, the coincidence is displayed in the display 330, and next operation is performed. If the received data for auxiliary tray is different from the stored prescription data, the alarm signal control part 323 provides alarm control signal to the alarm signal generation unit 340, and the display control part 324 controls the display 330 to show the no coincidence situation. Preferably, the interface part 321, the comparison part 322, the alarm signal control part 323 and the display control part 324 communicate internally with one another. Then the alarm signal generation unit 340 receives the alarm control signal and provides alarm signal to the alarm device 400.

The alarm device 400 generates visual and/or audio alarms so that the pharmacist handling the auxiliary tray should recognize the auxiliary tray 100 currently placed on the tray 12 is misplaced. The alarm device 400 may be placed anywhere on the STS 10. Since the situation that the alarm device 400 is activated is one in which an auxiliary tray containing medicines different from prescription is placed on the STS, alarm is immediately given to the user.

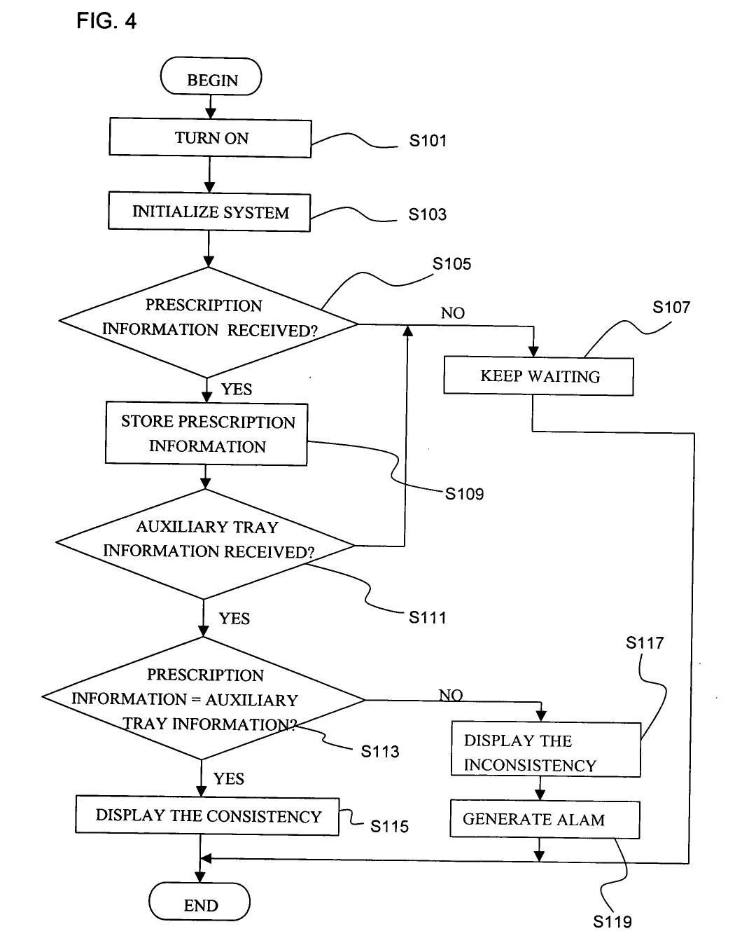

FIG. 4 shows an information recognition method according to the present invention. Steps S101˜S105 are supplying power, initializing the apparatus, and checking whether prescription information is received. Step S107 is waiting when there is no prescription information is received. Step S109 is storing the prescription information in a memory when there is prescription information received. Step S111 is checking whether auxiliary tray identification information is received. Step S113 is comparing the prescription information stored in step S109 and the auxiliary tray identification information when the auxiliary tray identification information is received. Steps S115˜S119 are displaying comparison result on the display, and generating alarm.

With the information recognition method, in step S101, power is supplied to the apparatus. In step S103, initialization of the entire operation of the apparatus is performed. In step S015, whether the prescription information is received is checked.

If there is no prescription information received, waiting status is kept in step S107. Otherwise, the received prescription is stored in the memory 350 in step S109.

In step S111, whether the auxiliary tray identification information is received is checked. If the auxiliary tray identification information is not received, there is no change. If the auxiliary tray identification information is received, the process moves to step S113, in which the prescription information stored in the memory and the received auxiliary tray identification information are compared.

If the prescription data and the auxiliary tray identification information coincide, the result is displayed in step S115, and the process proceeds to next operation. Otherwise, in step S117, the no coincidence is displayed, and visual and/or audio alarms are generated in step S119.

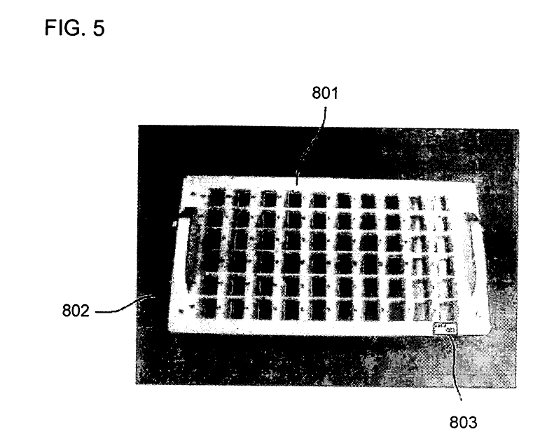

FIG. 5 shows an auxiliary tray 801 having a slide plate, a lever 802 that facilitates movement of the slide plate, and a marking device 803 that indicates information for medicines that are contained in the auxiliary tray, and corresponding patient information.

When a pharmacist sets medicines to be prepared with the auxiliary tray 801, marking information is transmitted to the marking device 803 via a marking device controller 500. The marking device 803 indicates the medicine information and the patient information so that the pharmacist or other personnel may easily identify the medicine and patient for the auxiliary tray.

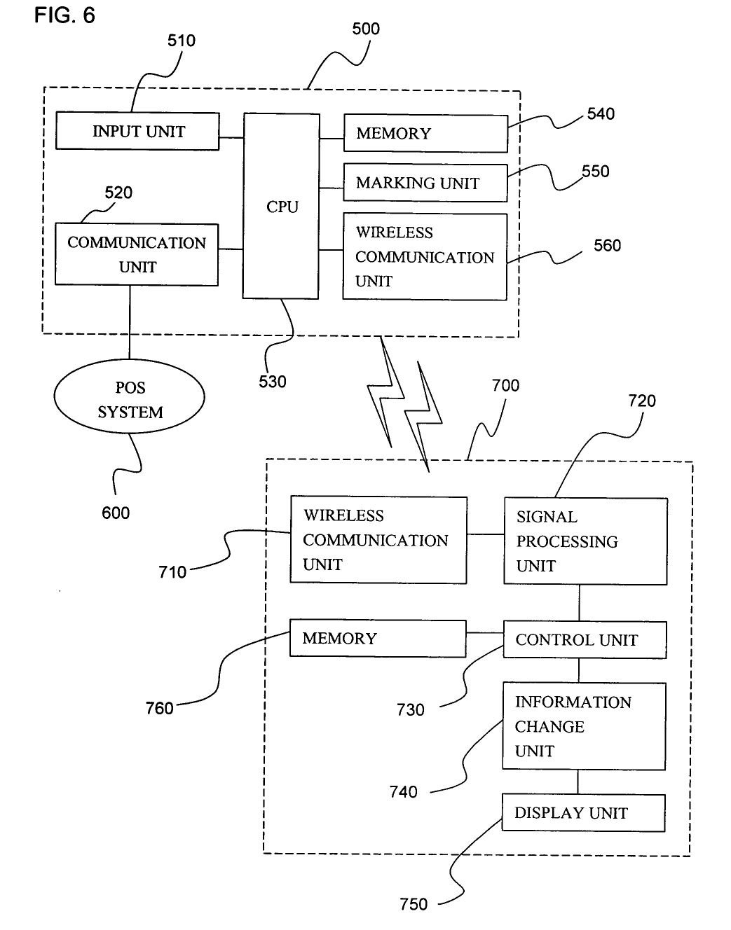

FIG. 6 shows the marking device controller 500 and a marking device 700. The marking device 700 is installed on the auxiliary tray 801 and records the medicine information and the patient information. The marking device controller 500 is connected to the marking device 700 and a POS system 600 via communication network, and transmits marking information (medicine information and patient information) to the marking device 700.

The marking device 700 includes a wireless communication unit 710 that receives the marking information that was transmitted from the marking device controller 500 and transmits identification information to the marking device controller 500; a signal processing unit 720 that removes noise from the received signal, extracts pure data signal and converts it into a digital signal; a control unit 730 that performs authentication and analysis of the signal processed by the signal processing unit 720 and as a result of the authentication/analysis, if the signal is of its own, controls change of currently displayed information; a memory 760 stores program for authentication/analysis of information and information for display, and is connected to the control unit 730; an information change unit 740 that performs change of displayed information and is connected to the control unit 730; and a display unit 750 that is connected to the information change unit 740 and displayed information of the auxiliary tray (medicine information, patient information).

The marking device controller 500 is a kind of electronic shelf label (ESL) system. The marking device controller 500 includes an input unit 510 that receives input for information to be recorded to the marking device 700, 803 and information that changes; a communication unit 520 that communicates with a POS system 600 and receives record information and change information for each marking device in real time; a central processing unit 530 that is connected to the input unit 510 and the communication unit 520 and controls transmission of the marking information and the change information. A marking unit 550 that displays transmission data for a particular marking device, a wireless communication unit 560 that that transmits marking information to the marking device 700, and a memory 540 that stores control program and generated data are connected to the central processing unit 530.

The second embodiment of auxiliary tray information identifying device having the above construction is explained referring to FIGS. 5-7.

As shown in FIG. 5, the marking device 802 that is attached on a predetermined location on the auxiliary 801 enables easy identification by a pharmacist.

It is possible to change information displayed by the marking device 803 in real time.

The central processing unit 530 of the marking device controller 500 chooses a particular auxiliary tray via the input unit 510. When display information or change information for the marking device 700 attached on the particular auxiliary tray is input, the central processing unit controls the marking unit 550 to display the chosen auxiliary tray and the information therefore so that a user who intends to change may easily check whether the changed information is precise.

When the information is precise, marking information is transmitted to the marking device 700 via the wireless communication unit 560. In the marking device 700, it is received via the wireless communication unit 710; the signal processing unit 720 processes the received signal; and the processed signal is applied to the control unit 730.

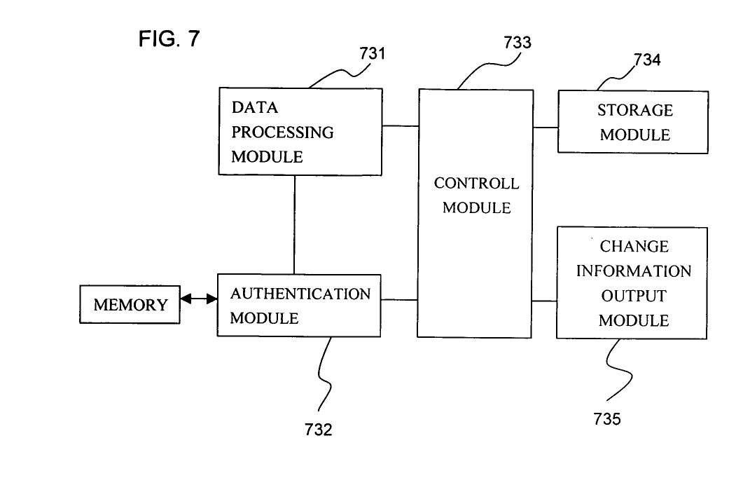

FIG. 7 shows that the control unit 730 includes a data processing module 731 that processes the received data and separates a unique number and data, and an authentication module 732 that performs authentication by comparing the separated unique number and its own unique number that is stored in the memory 760.

When the unique numbers are the same, a control module 733 controls the received data to be stored in the memory 760 via a storage module 734 and controls the change information to be output via a change information output module 735.

The information change unit 740 converts the change information that is output from the change information output module 735 and provides it to the display unit 750. The display unit 750 substitutes the currently displayed information with the change information and displays it.

The marking device 700 displays the medicine information and the patient information visually, and may be implemented with a price card, liquid crystal display, flexible numeric display, DOT matrix, or any display that can change information that is displayed.

While the above embodiment illustrated one marking device controller and one marking device connected thereto, practical implementation of the present invention includes one marking device controller and multiple marking devices. The unique number is used to identify an auxiliary tray since in most cases the information displayed by each marking device differs.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An apparatus for identifying information regarding an auxiliary tray, wherein the auxiliary tray is used to supply medicines to a tray of a special tablet system for an automatic medicine packing system, wherein the tray is positioned on a slide member, the apparatus comprising:
a) an electronic tag that is attached on a predetermined location on the auxiliary tray, wherein the electronic tag stores patient and medicine information;
b) an information reader that retrieves information from the electronic tag without contacting the electronic tag; and
c) a terminal that compares information read from the electronic tag and a prescription information;
wherein the terminal recognizes the auxiliary tray as the correct auxiliary tray if the informations are the same, and issues an alarm if the informations are different.

2. The apparatus of claim 1, further comprising an alarm device that is connected to the controller and generates an alarm.

3. The apparatus of claim 2, wherein the electronic tag is an RFID tag, wherein the information reader is an RFID information reading device.

4. The apparatus of claim 3, wherein the medicine information and the patient information stored in the RFID tab can be changed.

5. The apparatus of claim 4, wherein the RFID information reading device comprises an RFID reader that reads information stored in the RFID tag, a central processing unit that controls transmission of information read with the RFID reader, and a transceiver that transmits information that is output from the central processing unit to an external device according to a predetermined communication protocol.

6. The apparatus of claim 4, wherein the RFID information reader is attached on a predetermined location on the slide member.

7. The apparatus of claim 3, wherein the terminal comprises a transceiver that receives an auxiliary tray reading information that is transmitted from the RFID information reading device, a control unit that compares the auxiliary tray reading information and the prescription information that is supplied in advance, and issues alarm control signal if the informations are different, a display that displays the auxiliary tray reading information and the prescription information on a screen, a memory that stores the prescription information and a program for the comparison and issuing alarm, and an alarm signal generation unit that generates alarm signal when the control unit issues alarm control signal, and transmits the alarm signal to the alarm device.

8. The apparatus of claim 7, wherein the control unit comprises an interface part for data interface between the transceiver, the display, the alarm signal generation part, the memory, and the external device, a data comparison part that compares the auxiliary tray information and the prescription information; an alarm signal control part that controls generation of alarm signal, and a display control part that controls the display.

9. The apparatus of claim 2, wherein the alarm device is attached on a predetermined location on the slide member.

10. The apparatus of claim 9, wherein the alarm device generates a visual alarm.

11. The apparatus of claim 9, wherein the alarm device generates an audible alarm.

12. A method for identifying information regarding an auxiliary tray, wherein the auxiliary tray is used to supply medicines to a tray of a special tablet system for an automatic medicine packing system, wherein the tray is positioned on a slide member, the method comprising steps of:
a) checking whether prescription information is received;
b) storing the prescription information in a memory when there is prescription information received;
c) checking whether auxiliary tray identification information is received;
d) comparing the prescription information and the auxiliary tray identification information when the auxiliary tray identification information is received; and
e) displaying comparison result on a display when the informations are the same, and displaying comparison result on the display and generating alarm when the informations are different.

13. The method of claim 12, further comprising a step of initializing the system when the system is turned on.

14. An apparatus for identifying information regarding an auxiliary tray, wherein the auxiliary tray is used to supply medicines to a tray of a special tablet system for an automatic medicine packing system, wherein the tray is positioned on a slide member, the apparatus comprising:
a) a marking device that is installed on the auxiliary tray and visually displays medicine information and patient information; and
b) a marking device controller that is connected to the marking device and a POS system via communication network, and transmits marking information to the marking device;
wherein the marking information comprises medicine information and patient information.

15. The apparatus of claim 14, wherein the marking device comprises:
a) a wireless communication unit that receives the marking information that was transmitted from the marking device controller and transmits identification information to the marking device controller;
b) a signal processing unit that removes noise from the received signal, extracts pure data signal and converts it into a digital signal;
c) a control unit that performs authentication and analysis of the signal processed by the signal processing unit and as a result of the authentication/analysis, if the signal is of its own, controls change of currently displayed information;
d) a memory stores program for authentication/analysis of information and information for display, and is connected to the control unit;
e) an information change unit that performs change of displayed information according to the control of the control unit; and
f) a display unit that displays information of the auxiliary tray according to output of the information change unit.

16. The apparatus of claim 15, wherein the marking device displays the medicine information and the patient information visually, and comprises a price card, liquid crystal display, flexible numeric display, or DOT matrix, that can change information that is displayed.

17. The apparatus of claim 15, wherein the control unit comprises a data processing module that processes the received data and separates a unique number and data, an authentication module that performs authentication by comparing the separated unique number and its own unique number that is stored in the memory, and a control module that controls the received data to be stored in the memory via a storage module and controls the change information to be output via a change information output module when the unique numbers are the same, wherein the change information output module outputs the change information according to the control of the control module.

18. The apparatus of claim 14, wherein the marking device controller comprises an input unit that receives input for information to be recorded to the marking device and information that changes, a communication unit that communicates with a POS system and receives record information and change information for each marking device in real time, a central processing unit that is connected to the input unit and the communication unit and controls transmission of the marking information and the change information, a marking unit that displays transmission data for a particular marking device, and a wireless communication unit that that transmits marking information to the marking device.
